(19) United States
(12) Patent Application Publication
(10) Pub. No.: US 2020/0020037 A1
(43) Pub. Date: Jan. 16, 2020

(54) Automated Anti Health Insurance Fraud and Abuse Methods and System

(71) Applicant: Louis Idrobo, Forest Hills, NY (US)

(72) Inventor: Louis Idrobo, Forest Hills, NY (US)

(21) Appl. No.: 16/034,336

(22) Filed: Jul. 12, 2018

(51) Int. Cl. G06Q 40/08; G06Q 10/10; G06Q 20/40

(52) U.S. Cl. CPC G06Q 40/08; G06Q 10/0635; G06Q 20/4016; G06Q 10/10

(57) ABSTRACT

A system and methods that automates health insurance processes, reduces fraud and abuse in health insurance and brings price transparency to the people. It aligns the interests of all the players involved by creating a website with full price transparency of healthcare costs by provider and communicating that data in time for patients to make informed decisions. Incentivizing methods including bonuses and penalties for physicians and patients are included and the net result is everyone including providers and corporations gains high quality health insurance while saving money.

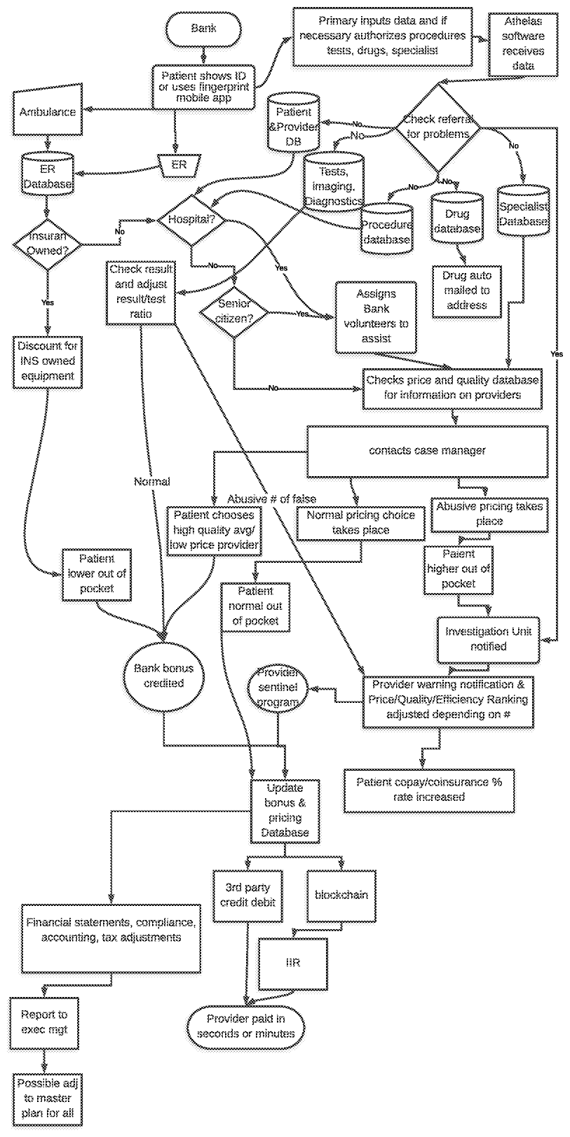

### CROSS-REFERENCE TO RELATED APPLICATIONS

This non-provisional application claims priority to U.S. Provisional Application No. 62/531,694 filed on Jul. 12, 2017 by Louis Idrobo entitled Automated Machine Implemented Anti-Health Insurance Fraud and Abuse Methods and Systems.

### BACKGROUND OF THE INVENTION

The field of the invention is health insurance in the United. States of America. The related art is a national disaster described by some such as Warren Buffet as the greatest problem in America. The problem of overly complex health insurance plans, procedures, and processing and high cost for the American people is extremely well known and has been the subject of much debate by experts and politicians with no solution discovered after many repeated attempts over a very long period of time. This is because the attempts have failed to address the root of the problem. Administrative costs in health insurance have oddly escaped the scrutiny of politicians. Part of the reason the insurance companies have continued increase rates without anything to stop them is extreme lack of transparency in both the healthcare and health insurance industry. The number of plans, the structure of the plans and the massive amount of statistics created have placed politicians in a situation where they are simply unable to come up with a solution. A very important part of the reason is convoluted statistics presented by insurance companies regarding the amount of administrative costs. They hide the mathematical fact that they waste so much money that if they did not exist, if someone could automate them, all Americans could have access to high quality low cost health insurance. This patent application presents a solution. The business method and system presented here enable the elimination of much of those administrative costs and consequently allow for the relief of the American people by enabling the significant reduction of health insurance premiums. Healthcare companies and corporations nationwide stand to benefit as well by the increased efficiency adding to their bottom lines $271 Billion on health insurance administrative costs by healthcare providers alone and $309 billion disappears from insurers revenues to the point of benefits paid. Health insurers have various powers at their disposal from lobbyists to special exemptions from antitrust laws that allow them to engage in collusive activities that are illegal for everyone else. A company is needed to disrupt the industry as various technology companies have done. Only then will the American people see relief from this problem. This patent is part of a strategy to attempt to accomplish that goal.

### BRIEF DESCRIPTION

The inventor intends that the anti-health insurance fraud and abuse method and system involves all the following methods, individually, as well as any and all combinations with each other. This includes the system with any components/elements removed from the system as a whole. The inventor intends and has confidence that the government/judicial system will do its duty to protect the interests of the inventor in exchange for the work and beneficial contributions to society contained within this application, and not attempt to limit the strength or allow supposedly, “intended”, constructs of the inventors application/patent that in truth the inventor does not intend, or interpret the invention in any way that will prevent inventor from enjoying his right to benefit from the patent without usurping attempts by competitors to steal them or wage disruptive litigation. The intent and spirit of the patent laws is to ensure a sufficient level of protection/intellectual territory surrounding the specification description and claims such that creative, strategic, patent opportunists are deterred from even attempting to challenge the patent of an inventor. Also, any vagueness or errors in patent language should not be used against inventors. To not do these things is to not honor the contract with inventors in good faith. Patent time limitation ensures that masses will eventually have full access to the entire intellectual contribution that results from the patent without undue harassment of inventors during the patent period. This is the true intent of the law and some courts have not honored this intent. The inventor believes that the highest levels of the great American judiciary understand and agree with this. In this particular application, the inventor believes that not only will the inventor benefit from granting of the patent, but that the American people will benefit as well because this patent is part of the creation of a new kind of insurance company that is needed to disrupt the health insurance industry in order to provide a desperately needed solution to the nation's health insurance woes and lower premiums. Established insurance companies will not implement the solution because it is not in their interest to do so and without the patent a strong challenger will probably be unable to emerge. The reasoning for the patent is to prevent traditional insurance companies from TEMPORARILY implementing the patent methods to prevent the rise of new competitors and continue the problem for Americans of high insurance premiums which the insurers clearly enjoy. The methods and systems generally include comparison between the number of tests ordered by healthcare providers (provider means physicians or other staff of hospital, or other form of medical practice) with the number of tests that result in a positive test result to detect abuse of testing/diagnostic systems. It is comprised of an electronic notification of a team of volunteer or employed or combination of different types of case managers to monitor and assist with prevention of the problem of providers overcharging seniors, the charging of seniors for unnecessary or fictitious tests, services or procedures. It also uses electronic notification of a team of volunteers (another variation/option/embodiment of the system includes, but is not limited to, the volunteers being replaced with employees or any combination of employee and volunteers) who also have a heightened focus on abusive hospital in-patient pricing. It addresses abusive pricing in general with the creation of and updates to a public pricing website and database that creates pricing transparency for patients. It checks provider referrals for self-referrals/problem referrals. It creates a universal efficient provider bonus system, the, “bonus” that is added to and subtracted from based on performance variables to encourage positive behavior. The system creates a method for tracking provider quality, efficiency and pricing. The method/system uses an automated quick response electronic communication (text/robocall/email) (or an alternative/variation of the system could include, but not be limited to, using humans to contact patients quickly with pricing information), to assist and incentivize patients in recognizing, locating and benefiting from choices in quality and/or price and finding lower cost good quality providers or any combination of quality or price. Quick communication would generally be comprised of same day communication, but could have alternative applications of communication before the patient seeks the referred treatment. It improves alignment of providers and patients interests with the overall goals of society by using a percentage for copayments and almost all patient interaction, but a variation could be without this component. Providers will authorize procedures and their authorizations will be tied into the bonus, ratings and patient reporting system for accountability. Identified inefficiencies in the mentioned items will be dealt with by the system automatically and in some cases, call upon human assistance. It uses databases of different types of providers, patients, conditions, prices and procedures to search for inefficiencies in the mentioned metrics. It creates a Health Insurance Crypto Token, the, “insurance token” and attempts to use this as payment for the provider bonus and for health insurance payments in general in order to create a token insurance capital reserve (some embodiments or variations may not include the token). By accepting all providers (in some embodiments not), using 1 plan for everyone (in some embodiments not) and being able to rely on doctors for authorizations due to the systems enhanced anti-fraud and abuse system the result is an incredibly streamlined computer based insurance company with extremely low administrative costs solving the health insurance problems of the nation. The embodiment that includes the creation of the insurance token capital reserve takes the solution even further. Another embodiment is comprised of using artificial intelligence to control the system and produce a completely automated or extremely highly automated health insurance company or using artificial intelligence to automate individual components of the system.

### BRIEF DESCRIPTION OF THE DRAWINGS

A flowchart from the CPU perspective showing the logical pathways

### REFERENCES CITED

For explanation of public ledger blockchain related technology

### U.S. Patent Documents

| | | |
|---|---|---|
| 9,635,000 | Apr. 25, 2017 | Muftic |
| 9,298,806 | March 2016 | Vessenes et al. |
| 9,344,282 | May 2016 | Yoo et al. |
| 9,344,425 | May 2016 | Belton et al. |
| 9,344,832 | May 2016 | Schell et al. |
| 2008/0244685 | October 2008 | Andersson |
| 2014/0344015 | November 2014 | Puertolas-Montaes |
| 2015/0026072 | January 2015 | Zhou |
| 2015/0164192 | June 2015 | Gross |
| 2015/0324787 | November 2015 | Schaffner |
| 2015/0356523 | December 2015 | Madden |
| 2016/0027229 | January 2016 | Spanos |
| 2016/0085955 | March 2016 | Lerner |
| 2016/0217532 | July 2016 | Slavin |
| 2016/0283941 | September 2016 | Andrade |
| 2016/0330027 | November 2016 | Ebrahimi |
| 2017/0011460 | January 2017 | Molinari |

TABLE-US-00001 U.S. Pat. No. 9,344,832 Shell, et al. U.S. Pat. No. 9,344,282 Yoo, et al. U.S. Pat. No. 9,344,425 Belton, et al. US 20080244685 Andersson, et al. US 20150164192 A1 Gross US 20150324787 A1 Schaffner, D. U.S. Pat. No. 9,298,806 B1 Vessenes, P. J. et al.

### OTHER PUBLICATIONS

ALI, M., et al., “Blockstack: Design and Implementation of a Global Naming System with Blockchains”, 2016 USENIX Annual Technical Conference (USENIX ATC'16) Bitcoin (web site) https://en.bitcoin.it/wiki, 2010 BitID (web site) “BitID Open Protocol”, http://bitid.bitcoin.blue/, 2015 BRICKELL, E., et al., “Direct Anonymous Attestation”, CCS '04, ACM 2004 pp. 132-145 Certificate Transparency (web site) https://www.certificate-transparency.org/CHAUM, D., “Security without identification: transactions system to make big brother obsolete”, CACM, 1985 Dot-bit (web site) http://dot-bit.org/ FROMKNECHT, C., et al., “CertCoin: A Namecoin based decentralized Authentication System”, MIT, Class 6,857 Project, May 14, 2014 FROMKNECHT, C., et al., “A Decentralized Public Key Infrastructure with Identity Retention”, MIT, Class 6,857 Project, Nov. 11, 2014 GARMAN, Ch., et al., “Decentralized Anonymous Credentials”, IACR Cryptology ePrint Archive, 2013:622, 2013 MAYMONIKER, P., at al., “Kademlia: A peer-to-peer information system based on the XOR metric”, http://kademlia.scs.cs.nyu.edu MELARA, M., et al., “CONIKS: Bringing Key Transparency to End Users”, 247h USENIX Security Symposium Namecoin (web site) https://www.namecoin.org/ REID, F. et al., “An Analysis of Anonymity in the Bitcoin System” in Security and Privacy in Social Networks, ed. Yaniv Altshuler et al. (New York: Springer, 2013), http://arxiv.org/pdf/1107.4524v2.pdf RON, D. et al., “Quantitative Analysis of the Full. Bitcoin Transaction Graph,” IACR Cryptology ePrint Archive 584 (2012), http://eprint.iacr.org/2012/584.pdf RFC 5280, Cooper, D. et al, “Internet X.509 Public Key Infrastructure Certificate and Certificate Revocation List (CRL) Profile”, IETF RFC 5280 RFC 6962, Laurie, B., et al., “Certificate Transparency”, RFC 6962, June 2013 ZYSKIND, G., “Decentralizing Privacy: Using Blockchain to Protect Personal Data”, MIT Media Lab

### DETAILED DESCRIPTION

### The Patient User Perspective:

The user will go on the internet and log onto the company website and create an account in the software system. Next the user will make payment of an insurance premium to the insurance company either using the Insurance crypto token through blockchain based technology or traditional 3^{rd} party credit/debit card systems. Once the payment is made the user/patient simply goes to the provider. Since the software will accept all providers and only have 1 plan to improve efficiency, patients will immediately know 2 key pieces of information: what their plan is and that their insurance accepts the provider. (Another variation/option/paradigm of the system includes, but is not limited to the patient logging onto their account to verify that their doctor is accepted by the insurance and then going to the provider or the system could offer multiple plans in the traditional manner or offer a very small number of plans or accept almost all providers with some exceptions.) With the preferred, “all providers accepted/1 plan for all”, variation the software has a very quick provider/insurance company agreement setup experience and a provider will be set up in seconds if they wish to accept the company's insurance on the spot. This is accomplished by having all doctors accepted and preloaded into the system. In the case where the doctor has not agreed already to accept the insurance, patients will be rewarded for talking to their providers for immediate acceptance of the insurance company for the patient's payment.

Once the primary provider authorizes a procedure or test through the software, the software will immediately communicate electronically (text, email, robocall or in another variation/option of the system through human contact) to communicate pricing for high quality local providers for that authorized item to the patient and also on the spot to the doctor for the doctor to communicate to the patient. Due to the % based copays the patient has a greater incentive to take pricing into consideration without putting a higher cost preferred provider out of reach by banning them outright. If the patient ends up choosing a provider that charges abusively, this will be noted and the patient will be notified that a slight increase to the % copay and % coinsurance rate will be made if it happens again. The consequence for the abusive provider will be deductions from the provider bonus (which is arranged such that all providers receive this bonus at certain dates throughout the year unless they engage in abusive behavior), and or providers have their payments delayed in comparison to the other providers) and reduction in the providers pricing rankings against other providers will be communicated to patients at critical decision-making moments.

### Provider User Perspective:

Provider will login to the system enter patient number/data and confirm identity. In another option/variation of the system, the patient will log into a cell phone app and use fingerprint to automatically be identified. The patient will see the doctor and the doctor/provider after entering visit data will be able to click a button and receive payment and approval within minutes. As stated previously physicians will be able to log into the system and order prescriptions and in another option variation of the system patients will be able to receive drone based delivery of medication directly to the person or to the person's home shortly after finishing with the provider. The physician will again be able to look up and authorize procedures, specialists, medication, and tests from his phone or desktop. In another option variation of the system the doctor will also be able to do all these things via voice recognition technology in order to have the opportunity to save time and be hands free or impress his or her patient. Upon an authorization the system will immediately notify the primary doctor of local providers for whatever the authorization requires near the patient and give pricing and quality rankings for those providers to provide the patient.

### The CPU/Computer or Smart Contract Perspective: (Also See Logical Flowchart)

The main CPU or smart contract is constantly active as it will be monitoring large databases of information and constantly checking and updating the mentioned anti-fraud and abuse methods and any methods that are subsequently added. Another variation/option/embodiment of the system includes, but is not limited to, an artificial intelligence system connected to the system to improve fraud detection capabilities. Upon a provider or patient user initiating interface with the system on their phone or computer due to a problem/illness/checkup the CPU will note the date and time of the event and wait for the primary provider to add details of the event and any authorizations. When said data is entered the software updates all relevant databases. Any authorizations will be checked for self-referral and for referral patterns of past referrals that could indicate abuse (for example all referrals going to the same person). Next, the authorization for a specialist/procedure/tests/medication is checked to see if the problem requires hospitalization. If yes, a team of volunteers lead by a company case manager will attempt to call the patient and be of assistance. If hospitalization was a no, then the CPU will check if the patient is elderly. If yes, then the same volunteer team will be called upon to assist with prevention of providers overcharging seniors, the charging of seniors for unnecessary or fictitious tests, services or procedures. If not elderly, then the CPU will proceed to the next stage of checking the provider pricing/quality database. **(Price & Quality Information—Insurance companies have special access to data. In this system pricing information is shared with the people in a very transparent manner such as a website/dedicated to pricing or a very prominent place on the insurance company website home page promoting and directing the people where to go. Another variation/option/alternative/embodiment of the system includes but is not limited to using Medicare allowable cost data and data from the relevant state the patient resides in to further enhance pricing knowledge of the people. The pricing database also contains provider quality information and also produces provider quality rankings. Public medical malpractice data is included in the quality database. Also, patients are rewarded with insurance tokens or dollars for providing additional illness/injury outcome data and ratings of their experiences and the illness/injury outcome data is factored into the quality figure. Providers are rewarded in insurance tokens or dollars for tracking and reporting patient BMI or Waist circumference to height data and this data and improvement in this data is factored into the provider quality rankings. In another alternative/variation of the system includes, but is not limited to patients confirming the BMI/Waist circumference data and being rewarded for that. Also, a number of 3rd party entities provide quality data for the database including federal and state entities that could further enhance the quality metric. The computer engineers use standard techniques like web crawling to capture public federal and state quality data for the database. The illness/outcomes information is given the highest weighting, followed by the malpractice data, followed by the BMI data)** Next, the CPU quickly uses an electronic communications method, text, email, robocall etc. to contact the patient and authorizing primary doctor. The patient is provided with local provider quality and pricing rankings with a clear breakdown of pricing implications if the patient should proceed with a provider with abusive pricing. If the patient clicks on a provider that has a history of abusive pricing and that provider also has average or below average quality ratings, the patient will be warned that their % copay and coinsurance % will go up and by how much if they proceed. Next, the CPU notes the choice of providers that the patient makes for the authorized item. The CPU or smart contract is constantly tracking providers to keep a history of abusive pricing eventually leading to an investigation team being notified for possible investigation of the provider. (In another variation of the system the patient is sent an additional electronic reminder if they are choosing a provider that has a history of abusive pricing and that also has average or below average quality ratings, highlighting the lower quality ratings.) Next, when the provider with abusive pricing enters the charge for payment from the insurance company the CPU checks the provider's history and decides whether to send a warning electronic communication to the provider or send a warning and also adjust the provider's price ranking for that occurrence. The provider is given a last opportunity to lower the charge. They can then be highlighted on the provider ranking's database and website for all patients to see if they are charging abusive prices while simultaneously having average or below average quality ratings. Next, the CPU decreases the amount of the abusive pricing provider's bonus (in another variation/option/embodiment of the system the bonus timeframe could also be extended for abusive providers.) This means efficient quality/price providers receive faster and larger bonuses and abusive ones receive smaller or no bonus and more delayed bonuses (quarterly, semiannually, etc.) and more delayed payment. Next, the CPU negatively adjusts the patient's copay % and coinsurance %. An abusive provider is defined as a provider that after adjusting for locality charges over 25% above average without having a quality ranking of similar level. Patients are rewarded for choosing providers that have high quality rankings and average or below average pricing ranking. (In another variation/embodiment of the system the abusive definition could be as low as 10% above average or more than 25% above average.)

If the patient chooses an efficient (high quality with average or below average price) provider that provider receives a credit to the provider bonus (Another variation/option the system includes, but is not limited to, the patient receiving a credit/reward to their account as well or the price component for an “efficient” provider to be higher than average)

Next the CPU proceeds to the payment stage and pays the provider either by going through traditional 3^{rd} party systems or a blockchain based payment (see blockchain references) using the, “Insurance token”, crypto, “currency”, (see blockchain references). Providers are paid in seconds or minutes (another variation/embodiment of the system includes, but is not limited to, abusive providers being paid in a slightly longer time frame, but still relatively fast (15 minutes)).

Another variation/embodiment of the system includes, but is not limited the creation of an insurance capital reserve using the crypto token owned in large quantities by the insurance company—once the insurance company reaches a certain size, the system communicates to all providers that all transactions will take place using the insurance token and increasing provider bonuses for doing so. The system will begin by doing this gradually with increased provider bonuses for using the reserve. This allows a large reserve of tokens held by an insurance company to transform into a massive unprecedented insurance reserve that when invested could generate great yearly income to the insurance company (allowing for the possibility of further reductions to the healthcare premiums of the American people when done by a responsible insurance company hence another reason for the need for this patent). In other words since the healthcare industry is massive and accounts for a significant percentage of GDP the enforced or promoted use of the insurance token could cause the token reserve held by the insurance company to grow massively in value as the demand for those tokens increases dramatically. This can potentially create an insurance reserve of 3 Trillion dollars or even more. The system creation of the insurance capital reserve is another preferred embodiment.

In another variation/embodiment of the system the system includes, but is not limited to, proceeding to update electronic versions of all the company's accounting/tax/financial/compliance statements with all the new data and make any corresponding calculations for the update. The CPU next proceeds to make automatic additions or deductions to and from the insurance reserve fund investments using self-managed exchange traded funds (ETFs). The reserve fund is the capital that the insurance maintains and invest for emergency coverage of claims. Regular reports will be sent to executive management. Upon notation of any discrepancy from company efficiency targets, a report will automatically be sent to executive management and the CPU could, if allowed by executive management, make adjustments to the master insurance plan affecting all customers/providers to safeguard the standing of the insurance company.

Another option/variation/embodiment of the system includes, but is not limited to the creation of a fully, nearly fully, or very highly automated, “smart”, machine software based health insurance company. The system when used in this way will be able to dramatically reduce health insurance company administrative costs by using very few employees. This embodiment will most likely be executed using the 1 plan/many providers method to increase efficiency for less need for human interaction. Eliminating much confusion for users of health insurance and for providers. This embodiment is one of the preferred embodiments as the inventor believes it is the solution to the nation's healthcare problems resulting in significantly reduced premiums for quality health insurance while fairly compensating providers. By accepting all providers, using 1 plan for everyone and being able to rely on doctors for authorizations due to the systems enhanced anti-fraud and abuse system, transparency and accountability, the result is an incredibly streamlined computer based insurance company with extremely low administrative costs solving the health insurance problems of the nation since administrative costs in the health insurance industry are inaccurately reported (many billions of dollars) and if eliminated are enough to significantly reduce premiums. The creation of the insurance token capital reserve takes the solution even further.

Using the preceding logic, corresponding logical flowchart, and established computer science concepts, a programmer/engineer of ordinary skill should be able to replicate the subject matter contained in this application.

The claimed system and methods are comprised of a transparent pricing website that uses internal insurance pricing data that the public has never seen and is also comprised of communicating to the public key information from this pricing website when they need it the most before getting treatment which has also never happened because due to resistance from health insurers and is also comprised of methods to align interests of physicians and patients and simplify and automate the health insurance procedures such that automation is possible and administrative costs a significantly reduced to save money for the American people.

1) I claim a method for fully or partially automating a health insurance company comprising a computer CPU executed system that checks for fraud and or abuse comprising a system that maintains prices charged by healthcare providers and or compensation of healthcare providers and quality information about healthcare providers and a computer or smart contract system that compensates or penalizes healthcare providers in relation to the quality/price information to solve the grave American problem of high health insurance administrative costs and bring down premiums.

2) I claim a method for automating fully or at least automating 20% of the operations of an average health insurance company comprising a smart contract system that executes itself (typically on a blockchain or other technology such as directed acyclic graph technology) and that checks for fraud and or abuse, and comprising a system that maintains prices charged by/compensation of healthcare providers and quality information about healthcare providers and a smart contract system that compensates or penalizes healthcare providers in relation to the quality/price information comprised of rewarding high quality healthcare providers that charge close to standard rates and penalizing healthcare providers that charge abnormally high rates while delivering near average or below average quality to solve the grave American problem of high levels of abuse, high health insurance administrative costs and high premiums.

3) I claim the method of claim #2 and further claim a method for automated fraud and abuse checking in health insurance comprising a smart contract system that executes itself (typically on a blockchain or other technology such as directed acyclic graph technology) that checks patient condition codes and procedure codes and or payment codes and looks for codes that are not appropriately matched for example for patient condition codes not matched with correct treatment codes or treatment codes not matched with correct payment codes and or checks for an unusually high number of treatment codes entered by providers for a certain condition and or checks for healthcare provider referral codes that refer continuously to the same provider and or provider referral codes that refer to a code controlled by, owned by the provider making the referral (generating conflicts of interest) and or checks for the most expensive codes always or nearly always or by 25% more than the average competitor being entered by providers and or checks/tracks the number of tests ordered by healthcare providers and compares that number with the number of tests ordered that actually result in a positive diagnosis and or tracks the test results of blood tests ordered and compares them to further blood tests results and tracks the progression of the results and gives healthcare providers rankings and or ratings based on the cumulative progression/worsening of their patients and for all analysis also tracks the performance of healthcare providers in relation to each other and ranks/rates that information and uses that information to increase or decrease a monetary or crypto token bonus depending on the performance in these metrics

4) I claim the method of claim #1 further comprising a computer CPU executed method for penalties for abusive behavior by health providers and rewards for fair pricing combined with high quality healthcare comprised of rewards providers by increasing or decreasing the claim authorization privileges that the health provider has with the health insurer in this automated system, also increasing or decreasing the speed at which payment is received, increasing or decreasing the ranking of the healthcare providers in relation to other healthcare providers.

5) I claim the method of claim #2 further comprising a smart contract executed method for penalties for abusive behavior by health providers and rewards for fair pricing combined with high quality healthcare comprised of rewards providers by increasing or decreasing the claim authorization privileges that the health provider has with the health insurer in this automated system, also increasing or decreasing the speed at which payment is received, increasing or decreasing the ranking of the healthcare providers in relation to other healthcare providers.

6) I claim the method of claim #4 and claim #5 further comprising a method of delivering medication executed by computer CPU or smart contract and that system commanding a drone to deliver the medication to the location where the patient is currently standing or to the home of the patient.

7) I claim the method of claim #1 further comprising a system executed by computer CPU of any kind such as desktop, cell phone or server or other that creates multiple levels of healthcare provider authorization with regard to health insurance claim approval comprised of a computer CPU or smart contract executed system that checks the ranking of the healthcare provider comprised of checking the quality ranking/rating (malpractice data/patient satisfaction data/outcomes data) compared to peers and prices charged by healthcare providers compared to peers/price rank and adjusts the privilege/authorization levels of healthcare providers based on this information.

8) I claim the method of claim #1 and 2 and further claim a method for automated acceptance of healthcare providers by health insurance companies comprised of offering a flat rate of the medicare rate plus 25% to all providers and accepting all healthcare providers and maintaining a list/profile of all healthcare providers in the country and allowing for quick automatic signup via the internet on a website and also allowing for patients to pay their deductible via internet and for the first two interactions with the patient instantly crediting the bank of the patient in order to provide quick payment to healthcare providers by the patient and further comprised of a method of simplifying insurance processes of having only 1, or 2 health insurance plans for all patients and accepting all healthcare providers executed via computer CPU or smart contracts on internet websites solving the problem of unnecessarily high complexity in the health insurance industry which is partly responsible for high health insurance premiums.

9) I claim the method of claim #1 further comprising a method for creating a public insurance pricing database comprising a computer CPU or smart contract executed system that uses any internal health insurance company pricing and payment information and shares that information with the public via computer system and internet in order to disrupt and solve the problem of a corrupt health insurance industry for the benefit of the American people as though counterintuitive it may be the only way to disrupt the industry and further comprising a computer CPU executed system that communicates to patients quality data (such as malpractice data and or ratings by patients) and pricing data sorted by healthcare provider for procedures/diagnostics/drugs/hospitals/specialists or whatever the requesting/authorizing healthcare provider has requested for the patient prior to the patient receiving the care to quickly show patients high quality healthcare providers are in fact available at reasonable prices via text message, chat, telephone, email or other form of communication to help solve abusive pricing and the major problem of price transparency in America and disrupt collusive health insurance practices.

10) I claim the method of claim #2 further comprising a smart contract executed system that uses any internal health insurance company pricing and payment information and shares that information with the public via computer system and internet in order to disrupt and solve the problem of a corrupt health insurance industry for the benefit of the American people and further comprising a smart contract executed system that communicates to patients quality data (such as malpractice data and or ratings by patients) and pricing data sorted by healthcare provider for procedures/diagnostics/drugs/hospitals/specialists or whatever the requesting/authorizing healthcare provider has requested for the patient prior to the patient receiving the care to quickly show patients high quality healthcare providers are in fact available at reasonable prices via text message, chat, telephone, email or other form of communication to help solve abusive pricing and the major problem of price transparency in America and disrupt collusive health insurance practices.

11) I claim the method of claim #9 further comprising a computer CPU executed system that communicates with peer to peer taxi or other taxi service type services to bring transportation to patients with their approval in order to conveniently transport them to higher ranked providers based on quality/price information to further incentivize patients to use provided high quality reasonably priced healthcare providers.

12) I claim the method of claim #11 further comprising a smart contract executed system that communicates with peer to peer taxi or other taxi service type services to bring transportation to patients with their approval in order to conveniently transport them to higher ranked providers based on quality/price information to further incentivize patients to use provided—com high quality reasonably priced healthcare providers.

13) I claim the method of claim #1 further comprising a method for creating a home health aid organization and or EMS ambulance service and or urgent care centers via decentralized autonomous organization (DAO) executed via smart contracts blockchain or other crypto technology that can be programmed to support the health insurance company without charging a markup eliminating middlemen and solving problems of high costs for americans.

14) I claim the methods of claims #1 and #2 and further claim the method use of decentralized autonomous organization technology to create health insurance departments comprising of computer CPU or smart contract executed systems that assist a health insurer reducing the need for the health insurer having to employ people comprised.

15) I claim the method of claim #1 and claim #2 and further claim a method for instantaneous approval of insurance claims comprising the steps of a provider or provider representative entering claim information and a computer CPU executed system checking the provider ranking/rating/privilege level of the physician and granting immediate approval of the claim based on high health provider rating.

16) I claim the method of claim #1 further comprising a method generated by computer CPU or human communication that communicates to doctors highly ranked in the computer system that they will be will receive a signing bonus comprised of influencing physician transfer to hospitals ranked highly by the system and out of hospitals lowly ranked by the computer system or another option would be to work directly for the insurance company.

17) I claim the method of claim #1 further comprising a computer CPU or blockchain executed method to improve insurance case manager performance comprised of the CPU or smart contract monitoring the number of cases handled, number of cases completed, number of complaints, quality and cost of patient's provider information and comparing that information with that of other case managers to generate a ranking for insurance case managers based on a ranking of each category and then an average score to generate a final ranking.

18) I claim the method of claim #1 further comprising a computer CPU or blockchain smart contract executed method that changes discounts offered to corporate customers of health insurers after checking, totaling, and averaging the quality/price data on the providers used by all of the employees of those corporate customers and compares those numbers to other corporations to generate a ranking of corporations solving the problem of corporation not bothering to use their considerable influence to push the healthcare and health insurance situation in the United States in the direction of improved efficiency and lower costs while maintaining high quality.

19) I claim the method of claim #2 further comprising smart contract executed method that changes discounts offered to corporate customers of health insurers after checking, totaling, and averaging the quality/price data on the providers used by all of the employees of those corporate customers and compares those numbers to other corporations to generate a ranking of corporations solving the problem of corporation not bothering to use their considerable influence to push the healthcare and health insurance situation in the United States in the direction of improved efficiency and lower costs while maintaining high quality.

20) I claim the method of claim #1 and claim #2 further comprising a method executed via computer CPU or smart contract for ranking home health aid performance comprising tracking home health aid complaint data and tracking ongoing blood test results of patients for improvement or worsening conditions and ranking home health aids by how much their assistance improves the health of the patients with increasing deductions to rank or rating as the number of complaints increases.

21) I claim the methods of claims 1 and 2 and further claim a method for providing a bonus from health insurance company to patients executed via CPU and or smart contract comprised of offering at least 5% health insurance premium and or copayment discounts to patients in return for healthy behavior (such as not smoking) and communicating that behavior to the health insurance company via internet website and for using higher ranked healthcare providers from the high quality/near industry average pricing group of healthcare providers ranking to partly solve the problem of patients individual interests not aligning with the interests of the nation resulting in abuse and high health insurance premiums.

22) I claim the method of all claims combined and further claim a method for nearly fully 60% or more or fully automating a health insurance company comprised of using computer CPU execution and or smart contract execution combined with artificial intelligence to analyze, execute and or improve methods of the automated health insurance company.
